(19) United States
(12) Patent Application Publication
(10) Pub. No.: US 2025/0154801 A1
(43) Pub. Date: May 15, 2025

(54) HIDDEN ACCESS FOR MANUALLY RELEASING LATCH OF VEHICLE BACK DOOR

(71) Applicant: Atieva, Inc., Newark, CA (US)

(72) Inventors: Alejandro Pinto, Dublin, CA (US); Cristian Alvaro Araneda Urrutia, Cupertino, CA (US)

(21) Appl. No.: 18/510,184

(22) Filed: Nov. 15, 2023

(51) Int. Cl. E05B 77/22; B62D 25/08; B62D 25/12; E05B 83/18

(52) U.S. Cl. CPC E05B 77/22; B62D 25/087; B62D 25/12; E05B 83/18

(57) ABSTRACT

A vehicle comprises: a vehicle body, occupant compartment and trunk space, the trunk space is not wholly separated from the occupant compartment, the trunk space having an opening to an outside, with a striker at an edge of the opening; a back door at the vehicle body providing access to the trunk space through the opening, a latch assembly is positioned in an interior of the back door to actuate a latch configured to engage with the striker and latch the back door, a lever is positioned in the interior of the back door to open the latch; and a hidden access at a surface of the back door that faces the trunk space when the back door is closed, the hidden access allowing the lever to be actuated, wherein the hidden access is provided other than using a visible hole or a visible door on the back door.

### TECHNICAL FIELD

This document relates to a hidden access for manually releasing a latch of a vehicle back door.

### BACKGROUND

Some vehicles in the United States are covered by regulations regarding automatic or manual safety release mechanisms for use when a person is inside a trunk compartment and the trunk lid is closed. When such a manual release mechanism is installed, Code of Federal Regulations section 571.401 requires it to be “easily seen” inside the closed trunk compartment. Vehicles are covered by this regulation if their trunk compartment is wholly separated from the occupant compartment by a permanently attached partition or by a fixed or fold-down seat back and/or partition.

Independent of regulation, many vehicle manufacturers have provided their vehicles with manual releases, including on liftgates and other back doors. Such manual releases are often not designed for the consumer, but rather are intended primarily for use during the manufacturer's assembly process, or later while the vehicle is at a vehicle dealer or service station. During assembly, a vehicle proceeds along a general assembly line where the various vehicle parts and components are installed in a specified order. For manufacturing reasons, it is often preferred to have the liftgate/back door remain open on the vehicle during the assembly process. For example, liftgates/back doors are sometimes kept ajar on the assembly line by placing a piece of polyurethane or other soft material in the opening. The liftgate/back door is typically not closed until essentially everything on the vehicle has been installed and is in place, and the vehicle has reached a final station of the assembly line. Nevertheless, during such an assembly process it may become necessary to use the manual release if the liftgate/back door should accidentally become closed. Moreover, having a manual release can be useful at a vehicle dealer or service station, where the vehicle's normal electronically controlled latch release mechanisms may be temporarily out of order.

In existing vehicles that have manual releases mainly intended for the assembly process or the vehicle dealer/service station, these manual releases are typically noticeable to a person using the vehicle. One approach that has been used is to leave a small hole in or near the latch mechanism, such that a small tool can be inserted to actuate the latch. This approach impacts the perception of vehicle quality because the hole remains visible and is located where it is likely to been noticed. In some cases, the hole is covered by a small door, typically of plastic material. However, the perception of vehicle quality is nevertheless impacted.

### SUMMARY

In a first aspect, a vehicle comprises: a vehicle body defining an occupant compartment and a trunk space, wherein the trunk space is not wholly separated from the occupant compartment, the trunk space having an opening to an outside of the vehicle body, wherein a striker is mounted at an edge of the opening; a back door mounted to the vehicle body to provide access to the trunk space through the opening, wherein a latch assembly is positioned in an interior of the back door to actuate a latch configured to engage with the striker and latch the back door, the latch assembly including a lever positioned in the interior of the back door to open the latch; and a hidden access at a surface of the back door that faces the trunk space when the back door is closed, the hidden access allowing the lever to be actuated, wherein the hidden access is provided other than using a visible hole or a visible door on the back door.

Implementations can include any or all of the following features. The hidden access comprises trim mounted to the surface and an opening that is hidden by the trim, the opening leading to the lever, wherein the trim is significantly larger than the opening, the trim configured for deflection at the opening for use of the hidden access. The trim comprises carpet covering substantially an entire width of the back door. The deflection comprises pushing a portion of the trim inward to expose the opening. The hidden access comprises a component that is mounted to an opening in the back door, the opening leading to the lever, the component having at least one vehicle function other than covering the opening, and wherein the component is removable from the opening for use of the hidden access. The component is a reflector. The component is a switch. The component is a lamp. The lamp is a puddle lamp mounted adjacent a lower edge of the back door. The latch assembly comprises a remote assist component that is separate from the latch, the remote assist component mounted in the interior of the back door, the remote assist component configured to actuate the latch using a cable connected between the remote assist component and the latch. The lever is located at the latch, and wherein the hidden access is positioned adjacent the latch. The vehicle is one of a sport utility vehicle or a minivan.

In a second aspect, a back door for a trunk space of a vehicle comprises: a back door body configured to provide access to the trunk space through an opening of the trunk space; a latch assembly positioned in an interior of the back door back door body to actuate a latch configured to engage with a striker mounted at an edge of the opening and latch the back door, the latch assembly including a lever positioned in the interior of the back door body to open the latch; and a hidden access at a surface of the back door that faces the trunk space when the back door is closed, the hidden access allowing the lever to be actuated, wherein the hidden access is provided other than using a visible hole or a visible door on the back door.

Implementations can include any or all of the following features. The hidden access comprises trim mounted to the surface and an opening that is hidden by the trim, the opening leading to the lever, wherein the trim is significantly larger than the opening, the trim configured for deflection at the opening for use of the hidden access. The trim comprises carpet covering substantially an entire width of the back door. The deflection comprises pushing a portion of the trim inward to expose the opening. The hidden access comprises a component that is mounted to an opening in the back door, the opening leading to the lever, the component having at least one vehicle function other than covering the opening, and wherein the component is removable from the opening for use of the hidden access. The component is a puddle lamp mounted at a lower edge of the back door. The latch assembly comprises a remote assist component that is separate from the latch, the remote assist component mounted in the interior of the back door, the remote assist component configured to actuate the latch using a cable connected between the remote assist component and the latch. The lever is located at the latch, and wherein the hidden access is positioned adjacent the latch.

### BRIEF DESCRIPTION OF DRAWINGS

FIG. 1 shows an example of a back door of a vehicle having a hidden access for manually releasing a latch.

FIG. 2 shows an example of removing the component mounted to an opening in the surface.

FIG. 3 shows where a cross section of the back door of FIG. 2 is taken.

FIG. 4 shows the cross section of the back door of FIG. 2.

FIG. 5 shows another example of a back door of a vehicle with a hidden access for manually releasing a latch.

FIG. 6 shows an example of a back door of a vehicle where a latch assembly includes a latch and a remote assist component.

FIG. 7 shows an example of a vehicle.

Like reference symbols in the various drawings indicate like elements.

### DETAILED DESCRIPTION

This document describes examples of systems and techniques that can provide hidden access to a manual latch release for a back door of a vehicle, the vehicle not being required by regulation to have an easily discernible manual release mechanism. The present subject matter can provide the cleanest design possible for the door and its latch assembly, while still providing the functionality of a manual latch release (e.g., which may be primarily intended for assembly personnel or service technicians). This can help provide a superior perception of quality compared to existing vehicles.

Examples herein refer to a vehicle. A vehicle is a machine that transports passengers or cargo, or both. As used herein, the term “vehicle” includes only those vehicles that are not required by regulation to have an easily discernible manual safety release mechanism in their trunk space. A vehicle can have one or more motors using at least one type of fuel or other energy source (e.g., electricity). The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle.

Examples described herein refer to a trunk space that is not wholly separated from the occupant compartment. As used herein, the term “trunk space” includes only those trunk spaces that are not required by regulation to have an easily discernible manual safety release mechanism in their trunk space.

Examples described herein refer to a hidden access to a lever of a latch assembly. As used herein, a hidden access refers to an access that allows the lever to be actuated, but wherein the presence of the hidden access is not visible and is not easily discernible. The hidden access may be provided through an opening in a panel or other substrate, but such opening is hidden from view (i.e., is not a visible opening). Moreover, the hiding of an opening is not done by covering the opening with a door (such as a piece of plastic).

Examples described herein refer to a front, rear, top, or a bottom. These and similar expressions identify things or aspects in a relative way based on an express or arbitrary notion of perspective. That is, these terms are illustrative only, used for purposes of explanation, and do not necessarily indicate the only possible position, direction, and so on.

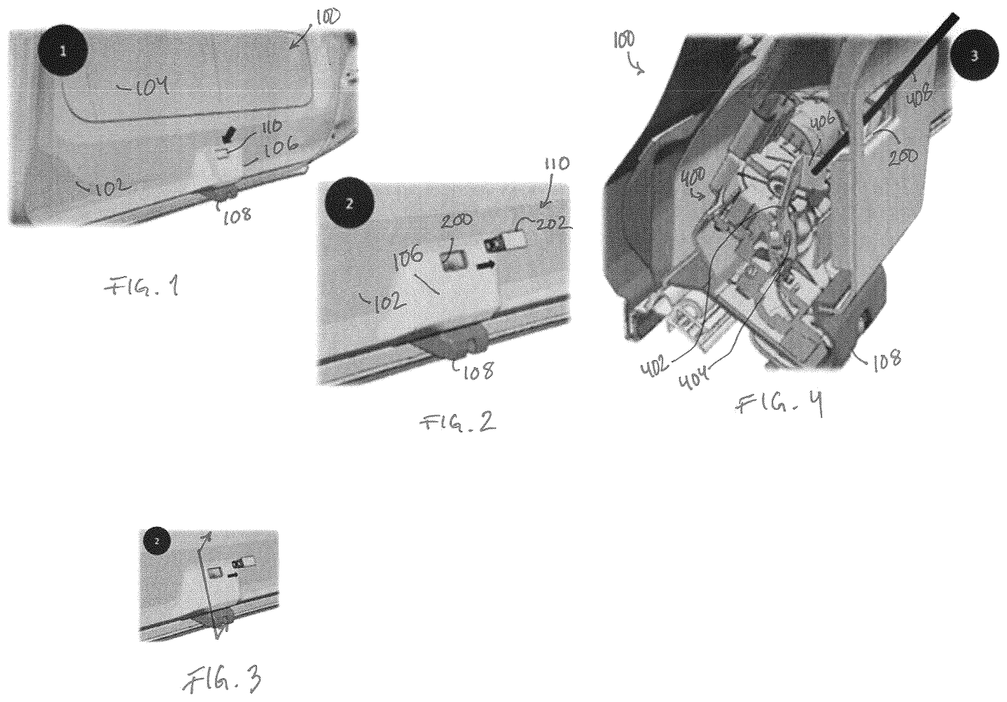

FIG. 1 shows an example of a back door 100 of a vehicle having a hidden access for manually releasing a latch. The back door 100 is here partially shown for simplicity and can be used with one or more other examples described elsewhere herein. In some implementations, the back door 100 is designed to be mounted at an opening to a trunk space of a vehicle such as a sport utility vehicle or a minivan. The back door 100 includes trim 102 and trim 104 that are mounted to a metal frame (not shown) that defines the structure of the back door 100. The trim 102 can include a shell of hard plastic material installed using clips, snap-on fasteners, or other retainers. The trim 104 can include fabric (e.g., a carpet material) attached to the trim 102 using adhesive.

A housing 106 is mounted to the back door 100 to partially cover a latch 108 positioned at a lower edge of the back door 100. The latch 108 is part of a latch assembly in the back door 100 and is configured to engage with a striker, mounted at an edge of the opening to the trunk space, to latch the back door 100. A component 110 is mounted to the housing 106. The component 110 may be something that the vehicle is not required to have. Rather, in some implementations, the decision to include the component 110 in the housing 106 as part of the design on the back door 100 can at least in part be driven by an interest in providing a hidden access to the latch assembly for manually releasing the latch 108. For example, the component 110 can include a lamp (e.g., a so-called puddle lamp designed for illuminating the ground next to the vehicle when the back door 100 is in an open position). As another example, the component 110 can include a reflector (e.g., the reflector can be installed so that it will assume a particular orientation when the back door 100 is in an open position). As another example, the component 110 can include a switch for electronically controlling a device of the vehicle (e.g., the device being an actuator for a power liftgate). The component 110 is here shown as positioned at the surface of the housing 106. In some implementations, the component 110 can instead be positioned at the surface of the trim 102 adjacent the location of the latch assembly. The surface of the housing 106 and the surface of the trim 102 both face the trunk space when the back door 100 is closed. Any surface of the back door 100 adjacent the latch assembly of the latch 108 can be used for the hidden access. The hidden access for manually actuating the latch 108 can be provided by the component 110, for example as will now be described.

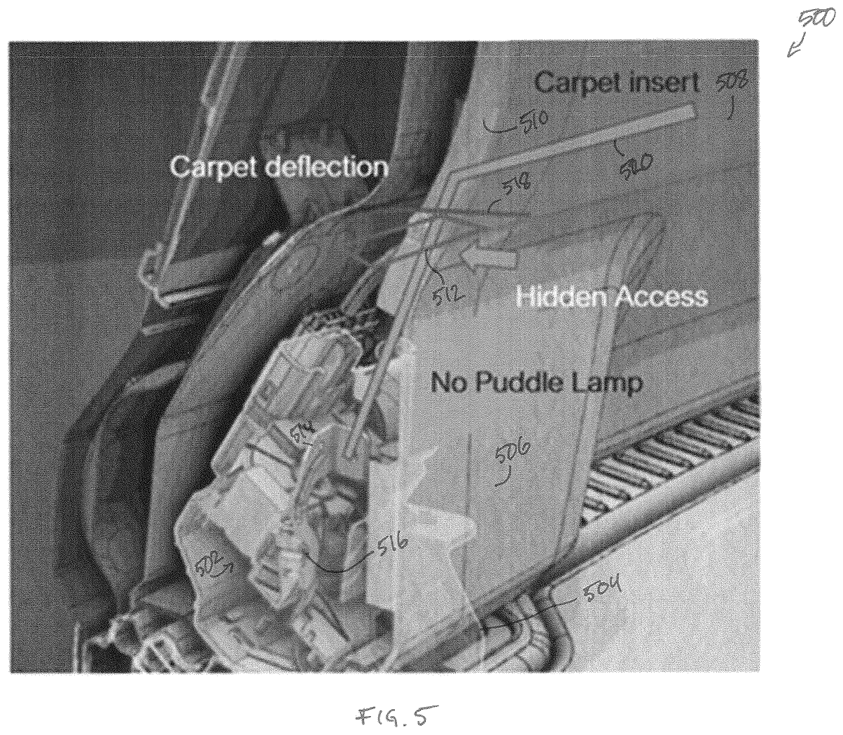

FIG. 2 shows an example of removing the component 110 mounted to an opening 200 formed in a surface. The opening 200 can be formed in the surface of the housing 106, or in the surface of the trim 102, to name just two examples. The component 110 can be pried out using a tool, such as a trim remover tool (e.g., a thin blade) that is commonly used to loosen interior vehicle trim. The component 110 can have a periphery 202 that ensures a secure yet removable fit within the opening 200 (for example, the periphery 202 can be formed by a flexible material that engages with the edge of the opening 200). When the component 110 is electronic, a cable (not shown) can extend out through the opening 200 after removal. The opening 200 can provide the hidden access that allows the latch 108 to be actuated, for example as will be described below with reference to a cross section. FIG. 3 shows where that cross section of the back door of FIG. 2 is taken.

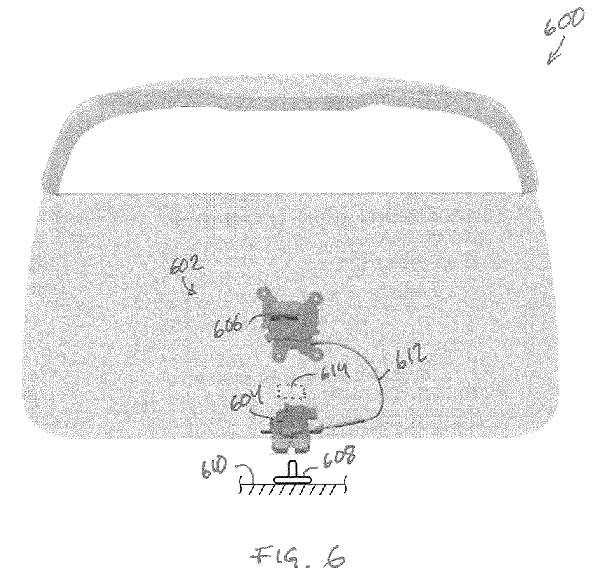

FIG. 4 shows the cross section of the back door 100 of FIG. 2. A latch assembly 400 is positioned in the interior of the back door 100. The latch assembly 400 is configured for actuating the latch 108. For example, the latch assembly 400 can be controlled using a mechanical handle or a switch on the outside of the back door 100, and/or remotely by electronic signal (e.g., facilitated by the vehicle's infotainment system). The latch assembly 400 has a lever 402 that is positioned in the interior of the back door 100 and reachable through the hidden access. The lever 402 is mounted to a pivot 404 that is coupled to the latch 108. For example, rotation of the lever 402 clockwise in the present illustration opens the latch 108. In some implementations, the lever 402 has a blade 406 that can facilitate the application of force in the correct direction by hand or using a tool. Here, a tool 408 is extending through the opening 200 to actuate the lever 402. The tool 408 can have a shape that is designed based on the geometry of the hidden access, including but not limited to based on the configuration of the opening 200 and the surface where it is placed, and/or the spatial relationship between the opening 200 and the latch assembly 400, including the lever 402. That is, the hidden access here allows the latch 108 to be actuated so that the back door 100 can be opened. The hidden access provided by removal of the component 110 from the opening 200 (FIG. 2) does not involve the existence of any visible hole or a visible door on the back door 100 before the operation. The component 110 (FIG. 1) can be replaced in the opening 200, thereby returning the back door 100 to the appearance it has in FIG. 1, wherein the hidden access is not discernible yet is available for use.

FIG. 5 shows another example of a back door 500 of a vehicle with a hidden access for manually releasing a latch. The back door 500 is mounted at an opening to a trunk space and can be used with one or more other examples described elsewhere herein. The back door 500 is shown in cross section in a view corresponding to that of the illustration in FIG. 4, for purposes of illustration. The back door 500 has a latch assembly 502 for a latch 504. The latch 504 is positioned inside a housing 506 on the back door 500 and is here substantially obscured because the back door 500 is depicted in a closed state, where the latch 504 has engaged with a striker, mounted at an edge of the opening to the trunk space, to latch the back door 500. In this example, the hidden access can be provided in another way, for example as will now be described.

The back door 500 includes trim 508. The trim 508 can correspond to the trim 104 (FIG. 1). In some implementations, the trim 508 includes fabric. In a trunk space the interior walls can be at least partially covered with fabric to offer resistance against scratching by luggage or other cargo being transported. The trim 508 can include carpet that is applied to the back door 500. The trim 508 can cover substantially an entire width of the back door 500 (e.g., as shown in FIG. 1). The trim 508 can be applied to a substrate 510 (e.g., by adhesive). The substrate 510 can be part of another trim panel (e.g., the trim 102 in FIG. 1) or can be installed to provide thermal and/or acoustic insulation. The substrate 510 may not normally be visible in the vehicle. An opening 512 is provided in the substrate 510, as here schematically illustrated using a rectangular shape. The opening 512 is a passage through the material of the substrate 510 that leads to a lever 514 of the latch assembly 502, the lever 514 being positioned in the interior of the back door 500 and mounted to a pivot 516 that is coupled to the latch 504.

When the vehicle has been assembled, the trim 508 (e.g., a carpet inset) covers a significant area of the inside of the back door 500, including the opening 512. For example, the trim 508 is significantly larger than the opening 512. As long as the trim 508 remains in place, the hidden access of the opening 512 is not discernible. However, the trim 508 can be configured to be deflected for use of the hidden access. A contour line 518 here schematically represents deflection of a portion of the trim 508. For example, because the material of the substrate 510 is not present where the opening 512 is located, the contour line 518 can correspond to pushing a portion of the trim 508 inward to expose the opening 512.

The hidden access that is realized by deflecting the portion of the trim 508 allows the lever 514 to be actuated by hand or using a tool. Here, a tool 520 is extending through the opening 512 to actuate the lever 514. Rotation of the lever 514 (e.g., clockwise in the present illustration) opens the latch 504. That is, the hidden access here allows the latch 504 to be actuated so that the back door 500 can be opened. The hidden access provided by deflection of the portion of the trim 508 does not involve the existence of any visible hole or a visible door on the back door 500 before the operation. The portion of the trim 508 can be restored to its original position (e.g., due to the elasticity of a carpet material), thereby returning the back door 500 to the appearance it had before the portion of the trim 508 was deflected, wherein the hidden access is not discernible yet is available for use.

FIG. 6 shows an example of a back door 600 of a vehicle where a latch assembly 602 includes a latch 604 and a remote assist component 606. The latch assembly 602 or any component thereof can be used with one or more other examples described elsewhere herein. The latch assembly 602 is positioned in the interior of the back door 600, which is here shown as transparent for illustrative purposes. The latch 604 is configured to engage with a striker 608 mounted to a structure 610. The structure 610 is part of an edge of the opening where the back door 600 is to be installed (e.g., a portion of the vehicle body at the opening of the trunk space). The remote assist component 606 is separate from the latch 604 and is configured to actuate the latch 604 using a cable 612 connected between the remote assist component 606 and the latch 604. A lever for manual release of the latch 604 can be positioned at the latch 604 (compare, e.g., with the lever 402 in FIG. 4 or the lever 514 in FIG. 5). A hidden access 614, here schematically illustrated using a dashed outline, can be provided at a surface of the back door 600, which surface faces the trunk space when the back door 600 is closed. For example, the hidden access 614 can include removal of the component 110 from the opening 200 (FIG. 2). As another example, the hidden access 614 can include deflection of the portion of the trim 508 (FIG. 5).

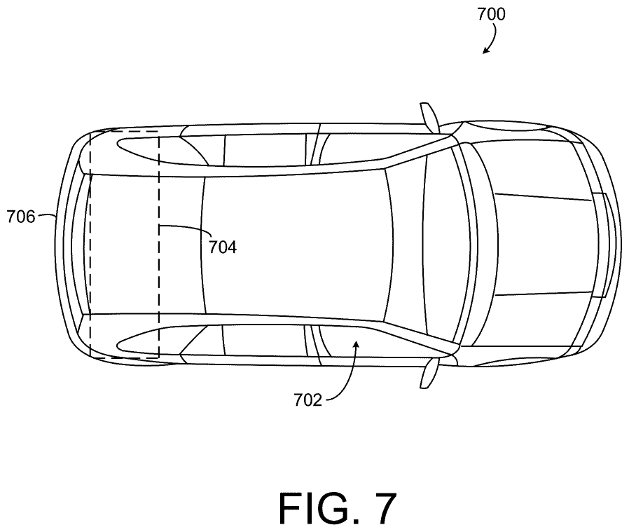

FIG. 7 shows an example of a vehicle 700. The vehicle 700 or any component thereof can be used with one or more other examples described elsewhere herein. The vehicle 700 is shown from above and has a vehicle body with an occupant compartment 702 that is here partially visible through the windows, and a trunk space 704 that is schematically illustrated using a dashed outline. The vehicle 700 is of a kind that is not required by regulation to have an easily discernible manual release mechanism. The trunk space 704 is accessible through a back door 706 and also, to some extent from the occupant compartment 702. The vehicle 700 can be a sport utility vehicle or a minivan, to name just two examples. The latch assembly of the back door 706 has a hidden access for providing manual latch release, for example as described above.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A vehicle comprising:
a vehicle body defining an occupant compartment and a trunk space, wherein the trunk space is not wholly separated from the occupant compartment, the trunk space having an opening to an outside of the vehicle body, wherein a striker is mounted at an edge of the opening;
a back door mounted to the vehicle body to provide access to the trunk space through the opening, wherein a latch assembly is positioned in an interior of the back door to actuate a latch configured to engage with the striker and latch the back door, the latch assembly including a lever positioned in the interior of the back door to open the latch; and
a hidden access at a surface of the back door that faces the trunk space when the back door is closed, the hidden access allowing the lever to be actuated, wherein the hidden access is provided other than using a visible hole or a visible door on the back door.

2. The vehicle of claim 1, wherein the hidden access comprises trim mounted to the surface and an opening that is hidden by the trim, the opening leading to the lever, wherein the trim is significantly larger than the opening, the trim configured for deflection at the opening for use of the hidden access.

3. The vehicle of claim 2, wherein the trim comprises carpet covering substantially an entire width of the back door.

4. The vehicle of claim 2, wherein the deflection comprises pushing a portion of the trim inward to expose the opening.

5. The vehicle of claim 1, wherein the hidden access comprises a component that is mounted to an opening in the back door, the opening leading to the lever, the component having at least one vehicle function other than covering the opening, and wherein the component is removable from the opening for use of the hidden access.

6. The vehicle of claim 5, wherein the component is a reflector.

7. The vehicle of claim 5, wherein the component is a switch.

8. The vehicle of claim 5, wherein the component is a lamp.

9. The vehicle of claim 8, wherein the lamp is a puddle lamp mounted adjacent a lower edge of the back door.

10. The vehicle of claim 1, wherein the latch assembly comprises a remote assist component that is separate from the latch, the remote assist component mounted in the interior of the back door, the remote assist component configured to actuate the latch using a cable connected between the remote assist component and the latch.

11. The vehicle of claim 10, wherein the lever is located at the latch, and wherein the hidden access is positioned adjacent the latch.

12. The vehicle of claim 1, wherein the vehicle is one of a sport utility vehicle or a minivan.

13. A back door for a trunk space of a vehicle, the back door comprising:
a back door body configured to provide access to the trunk space through an opening of the trunk space;
a latch assembly positioned in an interior of the back door back door body to actuate a latch configured to engage with a striker mounted at an edge of the opening and latch the back door, the latch assembly including a lever positioned in the interior of the back door body to open the latch; and
a hidden access at a surface of the back door that faces the trunk space when the back door is closed, the hidden access allowing the lever to be actuated, wherein the hidden access is provided other than using a visible hole or a visible door on the back door.

14. The back door of claim 13, wherein the hidden access comprises trim mounted to the surface and an opening that is hidden by the trim, the opening leading to the lever, wherein the trim is significantly larger than the opening, the trim configured for deflection at the opening for use of the hidden access.

15. The back door of claim 14, wherein the trim comprises carpet covering substantially an entire width of the back door.

16. The back door of claim 14, wherein the deflection comprises pushing a portion of the trim inward to expose the opening.

17. The back door of claim 13, wherein the hidden access comprises a component that is mounted to an opening in the back door, the opening leading to the lever, the component having at least one vehicle function other than covering the opening, and wherein the component is removable from the opening for use of the hidden access.

18. The back door of claim 17, wherein the component is a puddle lamp mounted at a lower edge of the back door.

19. The back door of claim 13, wherein the latch assembly comprises a remote assist component that is separate from the latch, the remote assist component mounted in the interior of the back door, the remote assist component configured to actuate the latch using a cable connected between the remote assist component and the latch.

20. The back door of claim 19, wherein the lever is located at the latch, and wherein the hidden access is positioned adjacent the latch.
